(19) United States
(12) Patent Application Publication
(10) Pub. No.: US 2019/0331163 A1
(43) Pub. Date: Oct. 31, 2019

(54) Turbocharger Bearing Housing with Non-Circular Bearing Bores

(71) Applicant: BorgWarner Inc., Auburn Hills, MI (US)

(72) Inventors: Kenneth R. Bischof, Arden, NC (US); Zachary S. Ashton, Arden, NC (US)

(73) Assignee: BorgWarner Inc., Auburn Hills, MI (US)

(21) Appl. No.: 15/966,838

(22) Filed: Apr. 30, 2018

(51) Int. Cl. F16C 17/18; F02C 6/12; F01D 25/16

(52) U.S. Cl. CPC F16C 17/18; F02C 6/12; F16C 2360/24; F05D 2220/40; F05D 2240/53; F01D 25/162

(57) ABSTRACT

A turbocharger includes a compressor wheel, a shaft, a bearing housing, and a floating ring. The shaft is coupled to the compressor wheel and extends through the bearing housing. The bearing housing includes an inner housing surface extending circumferentially around the shaft. The floating ring rotatably supports the shaft in the bearing housing and rotates relative to the bearing housing and the shaft. The floating ring includes an outer bearing surface that extends circumferentially around the shaft and that faces the inner peripheral housing surface. The inner housing surface is formed of a rigid material and has an inner housing cross-sectional shape that in a first axially outer region of the inner housing surface is non-circular perpendicular to the axis, decreases in area moving axially toward a first axial end, and forms a first outer fluid film interface with the outer bearing surface of the floating ring.

### CROSS-REFERENCE TO RELATED APPLICATION(S)

None.

### TECHNICAL FIELD

This disclosure relates to turbochargers and, in particular, bearing housings for turbochargers.

### BACKGROUND

A turbocharger is a forced induction device, which supplies compressed air to an internal combustion engine associated therewith. A turbocharger may include a turbine, which is rotated by exhaust gas from the engine, and a compressor, which is rotated by the turbine to compress the air supplied to the engine. The turbine and the compressor are connected to each other by a shaft and rotate at high rotational speeds, which may create vibrations and/or heat.

### SUMMARY

Disclosed herein are implementations of a turbocharger. In an implementation, a turbocharger includes a compressor wheel, a shaft, a bearing housing, and a floating ring. The shaft is coupled to the compressor wheel and extends through the bearing housing. The bearing housing includes an inner housing surface extending circumferentially around the shaft. The floating ring rotatably supports the shaft in the bearing housing and rotates relative to the bearing housing and the shaft. The floating ring includes an outer bearing surface that extends circumferentially around the shaft and that faces the inner peripheral housing surface. The inner housing surface is formed of a rigid material and has an inner housing cross-sectional shape that in a first axially outer region of the inner housing surface is non-circular perpendicular to the axis, decreases in area moving axially toward a first axial end, and forms a first outer fluid film interface with the outer bearing surface of the floating ring.

In an implementation, a turbocharger includes a turbine, a compressor, a shaft, a bearing housing, and a floating journal bearing. The turbine includes a turbine housing and a turbine wheel in the turbine housing. The compressor includes a compressor housing and a compressor wheel in the compressor housing. The shaft rotatably couples the turbine wheel to the compressor wheel, and includes an outer shaft surface. The bearing housing is positioned between the turbine housing and the compressor housing, and has the shaft extending therethrough. The bearing housing has an inner housing surface with a cross-sectional shape that is non-circular and that varies in size moving along an axis of the shaft. The floating journal bearing is positioned radially between and is rotatable independent of the inner housing surface and the outer shaft surface. The floating journal bearing includes an outer bearing surface. A first fluid film interface is formed between the inner housing surface and the outer bearing surface.

In an implementation, a turbocharger includes a shaft, a bearing housing, and a bearing. The shaft is coupled to a turbine wheel and a compressor wheel at opposite ends thereof. The bearing housing includes an inner housing surface with a radial dimension that varies moving circumferentially about an axis thereof and moving axially therealong. The inner housing surface defines a first bore. The bearing includes an outer bearing surface with another radial dimension that is constant moving circumferentially about another axis thereof and moving axially therealong. The inner bearing surface defines a second bore. The bearing is positioned in the first bore. The shaft extends through the second bore. A first fluid film interface is formed between the inner housing surface and the outer bearing surface. A second fluid film interface is formed between the inner housing surface and the shaft. The bearing rotates independent of the bearing housing and the shaft.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a cross-sectional schematic view of an exemplary embodiment of a turbocharger.

FIG. 2 is a cross-sectional schematic view of the turbocharger taken along line 2-2 in FIG. 1.

FIG. 3 is a cross-sectional schematic view of the turbocharger taken along line 3-3 in FIG. 1.

FIG. 4 is a cross-sectional schematic view of the turbocharger taken along line 4-4 in FIG. 1.

FIG. 5 is a cross-sectional schematic view of the turbocharger taken along line 5-5 in FIG. 1.

FIG. 6 is a superimposition of the cross-sectional schematic views of portions the turbocharger shown in FIG. 2 (shown in dash-dot lines), FIG. 3 (shown in long dashed lines), FIG. 4 (shown in solid lines), and FIG. 5 (shown in short dashed lines).

FIG. 7A is a plot of angular position vs. axial position of a peak of an inner surface of a bearing housing of the turbocharger of shown in FIG. 1.

FIG. 7B is a plot of angular position vs. axial position of another peak of another inner surface of another bearing housing that may be used in the turbocharger of shown in FIG. 1.

FIG. 7C is a plot of angular position vs. axial position of another peak of another inner surface of another bearing housing that may be used in the turbocharger of shown in FIG. 1.

FIG. 7D is a plot of angular position vs. axial position of another peak of another inner surface of another bearing housing that may be used in the turbocharger of shown in FIG. 1.

FIG. 7E is a plot of angular position vs. axial position of another peak of another inner surface of another bearing housing that may be used in the turbocharger of shown in FIG. 1.

FIG. 8 is a cross-sectional schematic view of another embodiment of a turbocharger.

### DETAILED DESCRIPTION

As discussed in further detail below, the present disclosure is directed to a bearing system for a turbocharger and a turbocharger comprising the same. The bearing system generally includes a bearing housing and a journal bearing, which cooperatively support a rotatable shaft. The bearing housing forms a fluid film interface with the journal bearing therein using a bore geometry that varies in radial dimension moving circumferentially about an axis thereof (e.g., being non-circular in cross-section) and moving axially therealong. By varying the radial dimension moving axially, the bearing system may provide improved stability and reduce noise as compared to bearing systems that do not vary in radial dimension moving axially, and may also control fluid flow for cooling and/or lubrication. The journal bearing forms another fluid film interface with the shaft therein, which may also use a bore geometry that varies in radial dimension moving circumferentially about an axis thereof and/or varies in radial dimension moving axially therealong.

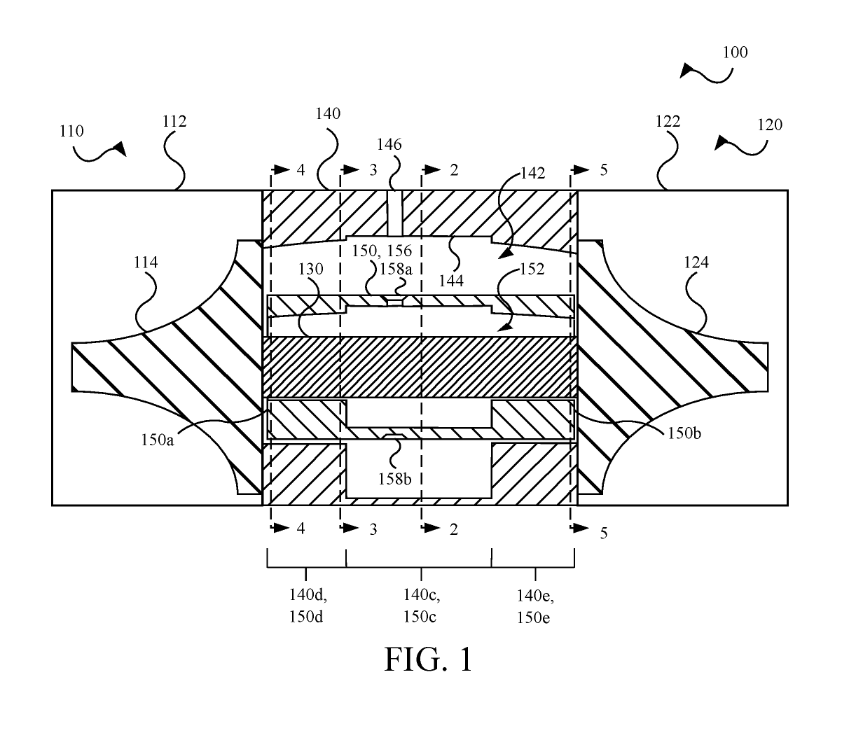

Referring to FIG. 1, a turbocharger 100 generally includes a turbine 110 and a compressor 120. The turbine 110 generally includes a turbine housing 112 and a turbine wheel 114. The compressor 120 generally includes a compressor housing 122 and a compressor wheel 124. The compressor wheel 124 is connected to the turbine wheel 114 with a shaft 130 to be rotated thereby. More particularly, the turbine 110 receives exhaust gas from an internal combustion engine (not shown), which rotates the turbine wheel 114 and, in turn, rotates the compressor wheel 124 to compress air for supply to the engine.

The turbocharger 100 additionally includes a bearing system having a bearing housing 140 and a journal bearing 150. The bearing housing 140 and the journal bearing 150 cooperatively rotatably support the shaft 130. The bearing housing 140 is arranged axially (e.g., in an axial direction) between and is coupled to turbine housing 112 and the compressor housing 122, for example, with threaded fasteners (not shown). The journal bearing 150 is arranged radially (i.e., in a radial direction) between the shaft 130 and the journal bearing 150. The axial direction is parallel with an axis 134 of the shaft 130 (and/or axes of the bearing housing 140 and the journal bearing 150, which are generally the same as the axis 134 of the shaft 130), while the radial direction is perpendicular to the axis 134.

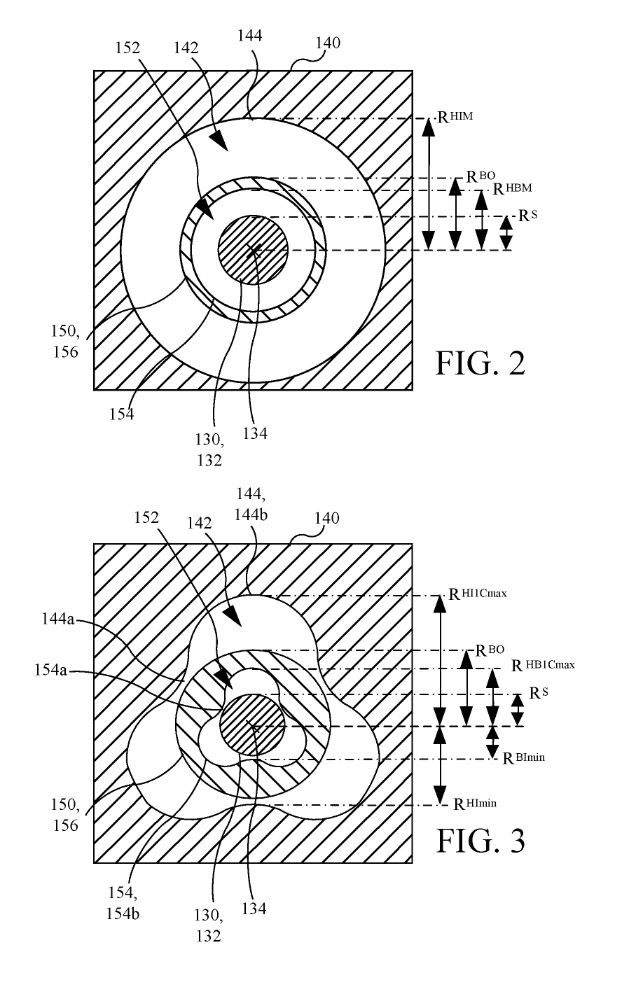

Referring additionally to FIG. 2, the bearing housing 140 defines a bore 142 in which the journal bearing 150 and the shaft 130 are positioned and rotate. More particularly, the bearing housing 140 includes an inner housing surface 144 that defines at least a portion of the bore 142 and that rotatably supports the journal bearing 150 therein. The inner housing surface 144 extends circumferentially entirely around an axis of the bearing housing 140. Fluid, such as oil received from the engine, forms outer fluid film interfaces (e.g., oil film interface) between the inner housing surface 144 and an outer bearing surface 156 of the journal bearing 150 (as discussed in further detail below) on left and right sides of the bearing system to, thereby, rotatably support the journal bearing 150 within the bearing housing 140. As discussed in further detail below, the inner housing surface 144 includes a geometry that may provide various functional benefits relating, for example, to stability, noise, vibration, speed, and/or fluid routing. The inner housing surface 144 may also be referred to as an inner peripheral surface, an inner circumferential surface, an inner peripheral housing surface, or an inner circumferential housing surface. The outer bearing surface 156 may also be referred to as an outer peripheral surface, an outer circumferential surface, an outer peripheral bearing surface, or an outer housing circumferential surface. The bore 142 may also be referred to as a cavity or a housing bore. The inner housing surface 144 may also be referred to as an inner peripheral surface, an inner peripheral housing surface, an inner housing bearing surface, or similar.

The bearing housing 140 is additionally configured to receive and distribute a fluid (e.g., oil from the engine) for lubricating and/or cooling various components within the bearing housing 140, such as the shaft 130 and the journal bearing 150. A fluid circuit may be cooperatively formed by various features of the bearing housing 140 and the journal bearing 150. For example, the bearing housing 140 includes a fluid passage 146 that is connectable to a fluid source (not shown), such as an oil pump associated with an oil circulation system of the engine, for receiving the fluid into the bearing housing 140. The fluid passage 146 extends radially inward to form a fluid outlet by which the fluid flows through the inner housing surface 144 into the bore 142. The outlet of the fluid passage 146 may be referred to as a housing outlet. The fluid passage 146 thereby communicates the fluid into the bore 142 of the bearing housing 140 to form the outer fluid film interfaces between the inner housing surface 144 of the bearing housing 140 and the outer bearing surface 156 of the journal bearing 150. As discussed in further detail below, the outlet of the fluid passage 146 may be located in an intermediate region between a first axial end 150a (e.g., near the turbine 110) and a second axial end 150b (e.g., near the compressor 120) of the journal bearing 150. The fluid received in the bore 142 may then flow between the inner housing surface 144 and the outer bearing surface 156 in opposite axial directions toward a first axial end 150a of the journal bearing 150 and a second axial end 150b of the journal bearing 150 and/or may flow radially inward through the journal bearing 150 to radially between the journal bearing 150 and the shaft 130.

The bearing housing 140 is a singular component or may be a multi-piece assembly, for example, being formed from a cast metal material (e.g., an aluminum, aluminum alloy, iron alloy, or steel alloy). The inner housing surface 144 is formed by a rigid material, such as the cast metal material otherwise forming the bearing housing 140, so as to not deflect under radial loading thereof by the journal bearing 150 (e.g., the inner housing surface 144 generally does not provide compliance for radial movement of the shaft 130). Alternatively, the inner bearing surface 144 may include an inner lining that is formed separate from and coupled to the bearing housing 140, such lining being formed of aluminum, aluminum alloy, iron alloy, steel alloy, bronze, or brass.

The journal bearing 150 is configured as a floating journal bearing that surrounds the shaft 130 and is arranged radially between the shaft 130 and the bearing housing 140. The journal bearing 150 is generally cylindrical and includes a bore 152 through which the shaft 130 extends. The journal bearing 150, by being a floating journal bearing, may rotate independent of the shaft 130 and the bearing housing 140. The outer fluid film interfaces are formed between the inner housing surface 144 and the outer bearing surface 156 of the journal bearing 150, and inner fluid film interfaces are formed between an inner bearing surface 154 that defines the bore 152 of the journal bearing 150 and an outer shaft surface 132 of the shaft 130. The outer bearing surface 156 and the inner bearing surface 154 each extend circumferentially entirely around an axis of the journal bearing 150. As discussed in further detail below, the inner bearing surface 154 includes a geometry that may provide various functional benefits relating, for example, to stability, noise, vibration, speed, and/or fluid routing. The inner bearing surface 154 may also be referred to as an inner peripheral surface, an inner circumferential surface, an inner peripheral bearing surface, or an inner circumferential bearing surface.

As referenced above, the journal bearing 150 rotates independent of the shaft 130 and the bearing housing 140. Rotation of the journal bearing 150 is caused by rotation of the shaft 130 (e.g., at high speeds) as torque is transferred therebetween (e.g., from shearing of the fluid forming the second fluid film interface therebetween). The journal bearing 150 rotates at a slower speed relative to the bearing housing 140 than does the shaft 130, for example, at 15-20% of the speed of the shaft 130 depending on operating conditions (e.g., temperature and/or speed). The journal bearing 150 may also be referred to as a floating ring, floating bearing, or floating ring bearing.

The journal bearing 150 is additionally configured to receive and distribute fluid for lubricating and/or cooling various components, such as the shaft 130 and the journal bearing 150. The journal bearing 150 may include a fluid passage 158a that extends radially from the outer bearing surface 156 to the inner bearing surface 154. The fluid may thereby flow from the bore 142 of the bearing housing 140 (i.e., from between the inner housing surface 144 and the outer bearing surface 156) into the bore 152 of the journal bearing 150 to form the inner fluid film interfaces between inner bearing surface 154 and the outer shaft surface 132 of the shaft 130. The journal bearing 150 may, in some embodiments, additionally include a circumferential channel 158b in the outer bearing surface 156 extending circumferentially therearound. The circumferential channel 158b may be axially aligned with both the outlet of the fluid passage 146 of the bearing housing 140 and the fluid passage 158a of the journal bearing 150, so as to maintain fluidic communication between the fluid outlet 146c and the fluid passage 158a even as the journal bearing 150 rotates relative to the bearing housing 140. The fluid received in the bore 152 of the journal bearing 150 may then flow between the inner bearing surface 154 and the outer shaft surface 132 in opposite axial directions toward the first axial end 150a of the journal bearing 150 and the second axial end 150b of the journal bearing 150.

The journal bearing 150 is a singular component, or may be a multi-piece assembly, formed by a rigid material, such as an extruded or cast metal material (e.g., brass and/or bronze). For example, the journal bearing 150 may be machined from a bar stock of material (e.g., extruded brass or bronze). The inner bearing surface 154 is formed by a rigid material, such as the extruded or cast metal material otherwise forming the journal bearing 150 (e.g., to generally not deflect under radial loading from the shaft 130). The journal bearing 150 may also be referred to as a ring, a floating bearing, a floating journal bearing, or a floating ring.

As referenced above, the inner housing surface 144 of the bearing housing 140 includes a geometry (e.g., a housing bore geometry) that may provide various advantages as compared to a conventional geometry. The inner bearing surface 154 of the journal bearing 150 may also include a geometry (e.g., a bearing bore geometry) that may also provide various advantages as compared to the conventional geometry. A conventional bore geometry may instead be constant in radial dimension moving circumferentially (i.e., being entirely circular) and axially (i.e., being cylindrical).

### Bearing Housing Geometry

Referring to FIG. 1 and additionally to FIGS. 2-6, the inner housing surface 144 has a geometry that varies in radial dimension moving circumferentially about the axis of the bearing housing 140 and also moving axially therealong. The inner bearing surface 154 of the journal bearing 150 may also vary in radial dimension moving circumferentially about the axis thereof and/or moving axially therealong.

For example, referring to FIGS. 1 and 2, the bearing housing 140 may include a axially central region 140c (e.g., a non-bearing region) that does not support the journal bearing 150 (e.g., does not form the outer fluid film interface) that is surrounded by first and second axially outer regions 140d, 140e (e.g., bearing regions) that support the journal bearing 150 by forming the outer fluid film interfaces (e.g., left and right fluid film interfaces as shown). In the axially central region 140c of the bearing housing 140, the inner housing surface 144 may have an inner dimension and define a cross-sectional area that is larger than dimensions of the first and second axially outer regions 140d, 140e. For example, the inner housing surface 144 may have a radius RHIM that is constant moving circumferentially around the axis 134 and moving axially therealong (e.g., between 25% and 75% of an axial length of the journal bearing 150, such as between 40% and 60% (e.g., approximately 50%). Moving axially from the axially central region 140c to each of the first and second axially outer regions 140d, 140e, the inner housing surface 144 may change in radial dimension abruptly, such as in a stepped manner.

In the dimensional nomenclature below for radial dimensions R, the first letter of the suffix generally refers to the component (e.g., “H” refers to the bearing housing 140, “B” refers to the journal bearing 150, and “S” refers to the shaft 130), the second letter generally refers to the surface (e.g., “I” refers to an inner surface, such as the inner housing surface 144, and “0” refers to an outer surface, such as the outer bearing surface 156 of the journal bearing 150), the third character generally refers to the axially-extending region (e.g., “M” refers to the central region or position between the turbine 110 and the compressor 120; “1” refers to a first axially outer region, such as the first axially outer region 140d, on a first, left, or turbine side of the journal bearing 150 relative to the middle position; “2” refers to a second axially outer region, such as the second axially outer region 140e, on a second, right, or compressor side of the journal bearing 150 relative to the middle position), the fourth character generally refers to the axial position within a region (e.g., “E” refers to a position at or near an end, such as the first and second axial ends 150a, 150b; “C” refers to a central position, such as at or near the axially central region 140c), and “max” and “min” refer to the maximum and minimum radial dimensions of the component at the specified location. Similarly, in the dimensional nomenclature below for the cross-sectional areas A, the first letter refers to the component (see above), the second letter refers to the surface (see above), and the third character refers to the axial region (see above). Letters, numbers, or characters may be omitted where not applicable, such as when referring to radial dimensions or areas more generally (e.g., over a side as opposed to end and central locations) or if there is no variation (e.g., having a constant value over different positions).

### Circumferentially-Varying Geometry of the Bearing Housing

With the radial dimension of the bore geometry varying moving circumferentially, the bore geometry may also be referred to as having a circumferentially-varying radial dimension, which results in the cross-sectional shape (e.g., the cross-sectional area) of the inner housing surface 144 being non-circular. The cross-sectional shapes discussed herein are taken perpendicular to the axis of the shaft 130. For example, the inner housing surface 144 (e.g., the cross-sectional shape or cross-sectional area thereof) may include a series of peaks 144a and valleys 144b having smaller and larger radial dimensions, respectively, measured from the axis 134 of rotation of the shaft 130. The radial dimension of the peaks 144a may be referred to as a peak radial dimension or minimum radial dimension, and the radial dimension of the valleys 144b may also be referred to as a valley radial dimension or maximum radial dimension. The peaks 144a and the valleys 144b alternate circumferentially and extend axially over a majority (e.g., an entirety) of the axial distance of the first axially outer region 140d (e.g., between the first axial end 150a of the journal bearing 150 and the axially central region 140c of the bearing housing 140, such as on the turbine side) and also the second axially outer region 140e (e.g., between the second axial end 150b and the axially central region 140c, such as on the compressor side of the journal bearing 150). As a result, each of the peaks 144a forms an axially-extending ridge, and each of the valleys 144b forms an axially-extending trough. The outer fluid film interfaces are formed between the peaks 144a of the inner housing surface 144 and the outer bearing surface 156 (e.g., two outer film interfaces, one in the first axially outer region 140d and another in the second axially outer region 140e).

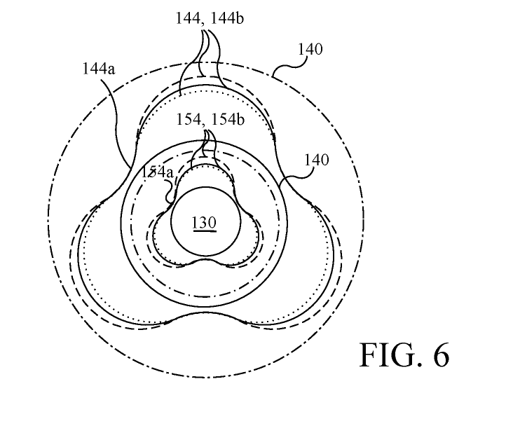

As shown, the inner housing surface 144 may include three of the peaks 144a and three of the valleys 144b therebetween, but may include fewer (e.g., two) or more (e.g., four, five, or more). The peaks 144a and/or the valleys 144b may also be referred to as lobes. For illustrative purposes, the radial dimensions of the bearing housing 140 are depicted in an exaggerated manner, and FIG. 6 superimposes the cross-sectional shape of the various components of the turbocharger 100 to illustrate the different radial dimensions at different axial positions. As discussed blow, the radial dimension may vary at each axial location (e.g., the difference between the radial dimensions of the peak 144a and the valley 144b at one axial position) by between 2 and 50 microns, or other suitable amount.

This circumferentially-varying radial dimension of the inner housing surface 144 may, as compared to the conventional geometry, reduce vibrations (e.g., sub-synchronous vibrations), reduce noise, control bearing temperature, increase rotational speed of the shaft 130, and/or increased stability at high rotational speeds of the shaft 130, as compared to conventional geometries of bearing housings and/or journal bearings. Sub-synchronous vibrations refer to vibrations causes by the journal bearing 150 rotating at a slower speed than the shaft 130.

Further, this circumferentially-varying radial geometry of the inner housing surface 144 may also assist in flow of the fluid. As shown by comparing the cross-sectional views in FIGS. 3-6, the peaks 144a and the valleys 144b of the inner housing surface 144 are at the same angular position at different axial positions, such that the axially-extending ridges formed by the peaks 144a and the axially-extending troughs formed by the valleys 144b each extend parallel with the axis.

Alternatively, the peaks 144a and the valleys 144b of the inner housing surface 144 may be at different angular positions at different axial positions, such that the axially-extending ridges formed by the peaks 144a and the axially-extending troughs formed by the valleys 144b each extend at least partially circumferentially around the axis 134. As a result, the peaks 144a and valleys 144b may function to assist in flow of the fluid toward and/or away from the first axial end 150a and/or the second axial end 150b. As the journal bearing 150 is rotated, an axial force is applied by the peaks 144a to push the fluid toward or away from the first axial end 150a and/or the second axial end 150b. For example, the peaks 144a may extend circumferentially between 5 degrees and 90 degrees from the first axial end 150a to the second axial end 150b.

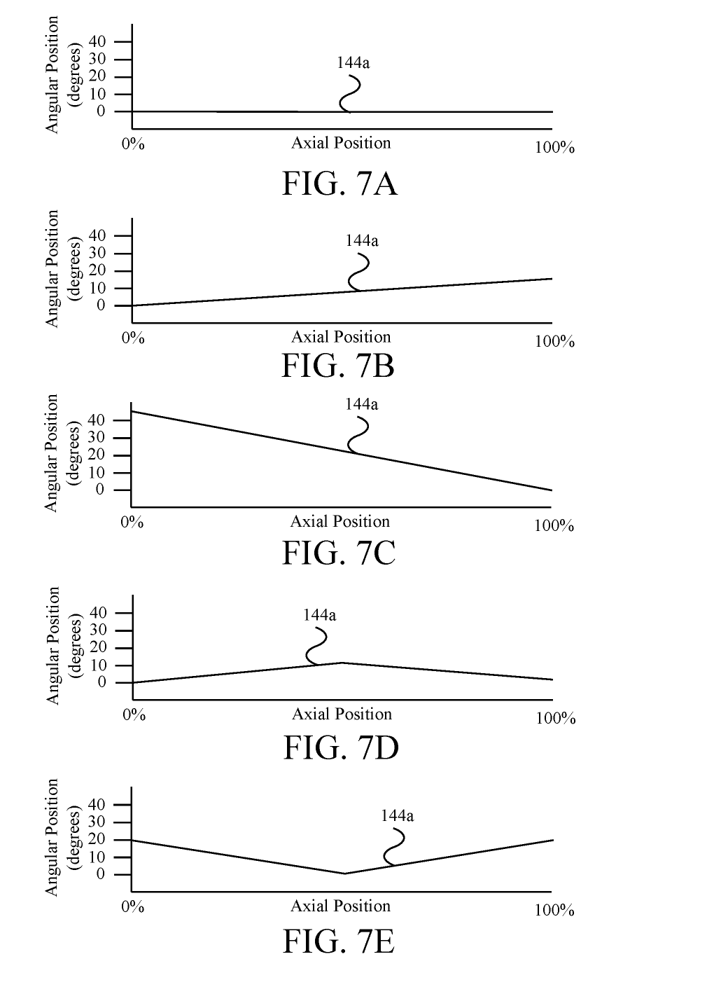

Referring to FIGS. 7A-7E, the angular position of each peak 144a is plotted against the axial position represented as a percentage of the axial distance within the first and second axially outer regions 140d, 140e (e.g., between the first axial end 150a or the second axial end 150b and the axially central region 140c), so as to illustrate the angular position of the ridge formed thereby relative to the axial position. As shown in FIG. 7A, the peaks 144a do not extend circumferentially (i.e., as shown in FIGS. 2-6). As shown in FIG. 7B, the peaks 144a extend circumferentially 20 degrees from the first axial end 150a to the second axial end 150b in the same direction of rotation as the journal bearing 150 (i.e., rolling down the page as shown), such that the fluid is pushed axially toward the second axial end 150b. As shown in FIG. 7C, the peaks 144a extend circumferentially 45 degrees from the second axial end 150b to the first axial end 150a in the same direction of rotation as the journal bearing 150 (i.e., rolling down the page as shown), such that the fluid is pushed axially toward the second axial end 150b. As shown in FIG. 7D, the peaks 144a extend circumferentially 10 degrees from an intermediate position to the first axial end 150a and the second axial end 150b in the direction of rotation, such that the fluid is pushed axially outward from the intermediate region to each of the first axial end 150a and the second axial end 150b. As shown in FIG. 7E, the peaks 144a extend circumferentially 20 degrees from each of the first axial end 150a to the second axial end 150b in the direction of rotation, such that the fluid is pushed axially inward from the first axial end 150a and the second axial end 150b (e.g., to retain fluid in the bore 142).

### Axially-Varying Geometry of the Bearing Housing

With the radial dimension of the bore geometry varying moving axially, the bore geometry of the inner housing surface 144 (e.g., the inner housing cross-sectional shape) may also be referred to as having an axially-varying radial dimension. More particularly, by reducing the maximum radial dimension of the inner housing surface 144 (i.e., the dimension of the valleys 144b) moving axially toward the first axial end 150a (e.g., on the turbine side) and/or the second axial end 150b, greater stability may be provided to the bearing system and reduced noise may be achieved as compared conventional bearing geometries. The minimum radial dimension of the inner housing surface 144 (i.e., the dimensions of the peaks 144a) may be constant in the first and second axially outer regions 140d, 140e. Further, by having the maximum dimension of the inner housing surface 144 reduce to a smaller dimension on one side (e.g., the first axially outer region 140d, such as the turbine side) as compared to the other (e.g., the second axially outer region 140e, such as the compressor side), the bore geometry allows the flow of fluid to be biased more toward the first axial end 150a or the second axial end 150b. For example, with the bore geometry having an axially-varying radial dimension, the cross-sectional shape of the inner housing surface 144 may have an area that varies moving axially (e.g., decreases moving axially outward), which may be referred to as an axially-varying cross-sectional area. The different areas allow unequal biasing of fluid flow between the first axial end 150a of the journal bearing 150 and the second axial end 150b of the journal bearing 150. That is, the fluid may flow in an axial direction between the inner housing surface 144 and the outer bearing surface 156 at uneven flow rates toward the first axial end 150a and the second axial end 150b. This uneven flow may be advantageous to control cooling of various components of the turbocharger 100 and to control a temperature of the fluid to limit rotational friction between the inner housing surface 144 and the outer bearing surface 156 (e.g., due to shearing of the fluid) and/or prevent oil burning (e.g., due to too high a temperature).

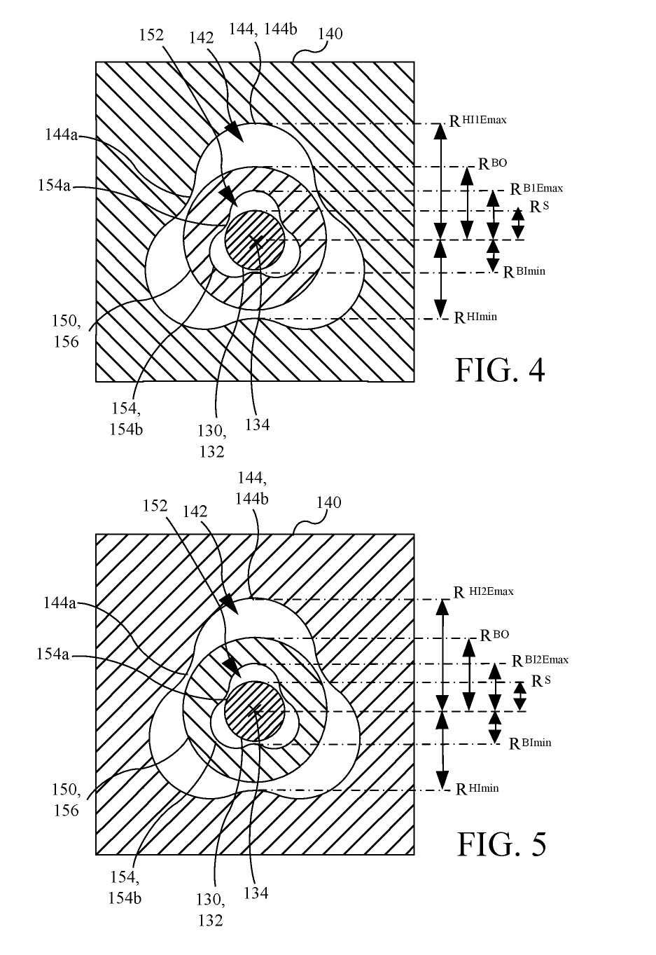

The axially-varying radial dimension and the axially-varying cross-sectional area are illustrated by comparing the cross-sectional views of FIG. 3 (taken at a central position in the first axially outer region 140d), FIG. 4 (taken at an end position in the first axially outer region 140d), FIG. 5 (taken at an end position in the second axially outer region 140e, such as the right or compressor side), and FIG. 6 (superimposition of the cross-sections of FIGS. 2-5).

FIG. 3 is a cross-sectional view of the turbocharger 100 taken in the first axially outer region 140d at a at a central position adjacent to the axially central region 140c (e.g., non-bearing region). The first axially outer region 140d may instead be on a compressor side of the turbocharger 100. At this central axial position, the inner housing surface 144 has a maximum radial dimension R_{HI1Cmax} measured from the axis 134 at one or more of the valleys 144b (e.g., all) and a minimum radial dimension R_{H1min} at one or more (e.g., all) of the peaks 144a. At the central position, the difference between the maximum radial dimension R_{HI1Cmax} and the minimum radial dimension R_{H1min} may, for example, be between 2 and 50 microns, such as between 15 and 40 microns, or other suitable dimension.

In the first axially outer region 140d, the maximum radial dimension R_{HI1max} (i.e., of the valleys 144b) of the inner housing surface 144 may be highest at the central position as compared to any other axial position. Thus, moving axially from the central axial position toward the first axial end 150a, the maximum radial dimension R_{HI1max} may decrease and/or stay constant. For example, as shown, the maximum radial dimension R_{HI1max} decreases moving from the central position toward the first axial end 150a of the journal bearing 150.

The minimum radial dimension R_{HI1min} of the inner housing surface 144 may, as shown, be constant over the axial distance of the journal bearing 150 (i.e., be the same at each axial position).

As a result of the maximum radial dimension R_{HImax} being highest at the central position and the minimum radial dimension R_{HImin} staying constant, the cross-sectional area A_{HI1} of the inner housing surface 144 (e.g., an inner housing cross-sectional area) in the first axially outer region 140d may also be highest at the central position. Further, as a result of the maximum radial dimension R_{HI1max} decreasing moving from the central position and the minimum radial dimension R_{HImin} staying constant, the cross-sectional area A_{HIM} defined within the inner housing surface 144 decreases moving from the central axial position axially toward the first axial end 150a. Thus, the cross-sectional area of the inner housing surface 144 varies in size between the central position and the end position (proximate the first axial end 150a) on the first (e.g., left or turbine) bearing region.

FIG. 4 is a cross-sectional view of the turbocharger 100 taken at a first end position on a first axial side of the bore 142 of the bearing housing 140. The first end position may be the position where the maximum radial dimension R_{HImax} is least on the first side of the bore 142. That is, the maximum radial dimension R_{HImax} reduces from its greatest value R_{HI1Cmax} at the central position to its lowest value on the first side of the bore 142, which is R_{HI1Emax} at the first end position (i.e., R_{HI1Cmax}<R_{HI1Emax}) and may be referred to as a smallest valley radial dimension or minimum valley radial dimension.

The maximum radial dimension R_{HImax} may, as shown in FIG. 1, change gradually moving axially (e.g., having smooth surfaces without steps). For example, the maximum radial dimension R_{HI1max} may decrease at an increasing rate moving axially outward (i.e., toward the first axial end 150a), such as by following a curve having a constant or reducing radius (e.g., a parabolic curve), or may decrease at a constant rate (e.g., following a linear path). Alternatively, the maximum radial dimension R_{HI1max} may stay constant moving from the central position to the first axial end (i.e., R_{HI1Cmax}=R_{HI1Emax}). At the first end position, a difference between the maximum radial dimension R_{HI1Emax} and the minimum radial dimension R_{HImin} may, for example, be between 2 and 50 microns, such as between 4 and 20 microns, or other suitable dimension. In some applications, at the first axial end position, the difference between the maximum radial dimension R_{HI1Emax} and the minimum radial dimension R_{HImin} may be zero, such that the inner housing surface 144 has a circular cross-sectional shape at the first axial end position.

In the second axially outer region 140e, the maximum radial dimension R_{HImax} of the inner housing surface 144 may reduce in the same or similar manner as in the first axially outer region 140d. The second axially outer region 140e may be symmetric to the first axially outer region 140d, or may be different (e.g., to provide different flow rates, as discussed below). FIG. 5 is a cross-sectional view of the turbocharger 100 taken at a second end position in the second axially outer region 140e of the bore 142 of the bearing housing 140. As shown, the second axial side is on the compressor side of the turbocharger 100, but may instead be on the turbine side of the turbocharger 100.

The second axial end position may be the position where the maximum radial dimension R_{HImax} is least on the second side of the bore 142 (e.g., forming the minimum valley radial dimension). The maximum radial dimension R_{HImax} on the second axial side may reduce (e.g., from a maximum value at another central position adjacent the central region) to its lowest value on the second side of the bore 142, which is R_{HI2Emax} at the second axial end position in the manners described previously (e.g., at increasing or constant rates moving axially toward the second axial end 150b). Alternatively, the maximum radial dimension R_{HI2max} may stay constant moving from the central position to the second axial end (i.e., R_{HI2Cmax}=R_{HI2Emax}). At the second axial end position, a difference between the maximum radial dimension R_{HI2Emax} and the minimum radial dimension R_{HImin} may, for example, be between 2 and 50 microns, such as between 4 and 20 microns, or other suitable dimension. In some applications, at the second axial end position, a difference between the maximum radial dimension R_{HI2Emax} and the minimum radial dimension R_{HImin} may be zero, such that the inner housing surface 144 has a circular cross-sectional shape at the second axial end position.

The maximum radial dimension R_{HImax} may be least at the second axial end position as compared to all other axial positions (i.e., R_{HI2Emax}<R_{HI1Emax}). As a result of the maximum radial dimension R_{HImax} being least at the second axial position and the minimum radial dimension R_{HImin} staying constant, the cross-sectional area A_{HI} of the inner housing surface 144 may also be lower in the second axially outer region 140e than in the second outer region (A_{HI2E}>A_{HI1E}). For example, the lowest or minimum cross-sectional area in the first axially outer region 140d may be lower than the lowest or minimum cross-sectional area of the inner housing cross-sectional shape in the second axially outer region 140e. Thus, with the outer bearing surface 156 having a constant cross-sectional shape and area (i.e., circular shape with constant diameter moving axially, as discussed below), a net cross-sectional area (i.e., A_{HI} minus A_{BO}) is lower in the second axially outer region 140e than in the first axially outer region 140d. This difference in net cross-sectional area provides that fluid flow (i.e., received into the bore 142 through the fluid passage 146 at an axial position between the first axial end position and the second axial end position, and flowing axially between the inner housing surface 144 and the outer bearing surface 156) is biased more toward the first axial end 150a than the second axial end 150b.

For example, as shown, the first axial end 150a is positioned near the turbine 110, while the second axial end 150b is positioned near the compressor 120. Thus, with the net cross-sectional area being larger at the first axial end position near the turbine 110 as compared to the second axial end position near the compressor 120, more fluid is biased toward the turbine 110. Biasing more fluid toward the turbine 110 may be desirable to cool components (or portions thereof) proximate the turbine 110 (e.g., a back wall of the turbine housing 112), which may be expected to be relatively hot due to the exhaust gas from the engine flowing therethrough, while less fluid may be biased toward the second axial end 150b to cool components proximate the compressor 120, which are expected to be relatively cool. Alternatively, more fluid may be biased toward the compressor 120 than toward the turbine 110. Fluid exiting axially from between the inner housing surface 144 and the outer bearing surface 156 may be used to cool and/or lubricate still further components of the turbocharger 100 and may ultimately be collected in a sump (not shown) of the bearing housing 140 to be cooled and recirculated to the engine and/or the turbocharger 100.

Alternatively, the maximum radial dimensions R_{HI1Emax}, R_{HI2Emax} and the cross-sectional areas A_{HI1E}, A_{HI2E} may be the same on each side (e.g., at each axial end) of the bearing housing 140, such that fluid flow is substantially equal therethrough.

### Journal Bearing Geometry

Referring still to FIGS. 2-5, the outer bearing surface 156 of the journal bearing 150 has a non-variable geometry, while the inner bearing surface 154 of the journal bearing 150 may, in some embodiments, vary in radial dimension moving circumferentially about the axis of the journal bearing 150 and/or moving axially therealong. For example, referring again to FIGS. 1 and 2, the journal bearing 150 may include an axially central region 150c (e.g., a non-bearing region) that does not support the shaft 130 (e.g., does not form the inner fluid film interface) and that is axially between first and second axially outer regions 150d, 150e (e.g., bearing regions) that support the shaft 130 by forming the inner fluid film interfaces (e.g., left and right inner fluid film interfaces as shown). The axially central region 150c and the first and second axially outer regions 150d, 150e of the journal bearing 150 may correspond to the axially central region 140c and the first and second axially outer regions 140d, 140e of the bearing housing (e.g., being the generally same in axial length and position), or may differ (e.g., being shorter in axial length). In the axially central region 150c of the journal bearing 150, the inner bearing surface 154 may have an inner dimension and define a cross-sectional area that is larger than dimensions of the first and second axially outer regions 150d, 150e, and may not form the inner fluid film interface (e.g., to not radially support the shaft 130 therein). The radius R_{BIM} in the axially central region 150c may be constant moving circumferentially around the axis 134 (e.g., being circular) and may be constant moving axially therealong (e.g., between 25% and 75% of an axial length of the journal bearing 150, such as between 40% and 60% (e.g., approximately 50%). Moving axially from the axially central region 150c to each of the first and second axially outer regions 150d, 150e, the inner bearing surface 154 may change in radial dimension abruptly, such as in a stepped manner.

### Outer Geometry of the Journal Bearing

As referenced above, the outer bearing surface 156 of the journal bearing 150 (e.g., the cross-sectional shape and/or the cross-sectional area thereof, which may be referred to as the outer bearing cross-sectional shape) is circular and cylindrical, such that the outer bearing surface 156 has an outer radial dimension R_{BO} that is the same at generally all angular positions therearound (i.e., being circular) and generally all axial positions therealong (i.e., being cylindrical). Thus, at each of the first position and the second positions on the first and second sides of the journal bearing, the journal bearing 150 has an outer bearing cross-sectional area that is circular and common in size.

It should be noted that the journal bearing 150 may include the fluid passage 158a, the circumferential channel 158b, or other surface features that are minor in area (e.g., forming less than 5% of the total surface area of the outer bearing surface 156) in the outer bearing surface 156, while the outer bearing surface 156 is still considered circular and/or cylindrical. With the outer radial dimension R_{BO} of the journal bearing 150 and minimum radial dimension R_{HImin} of the inner housing surface 144 being the same at all axial positions, the outer fluid film interfaces may be formed similarly in the first and second axially outer regions 140d, 140e (e.g., between the peaks 144a of the inner housing surface 144 and the outer bearing surface 156 of the journal bearing 150).

### Circumferentially-Varying Inner Geometry of the Journal Bearing

With the radial dimension of the bore geometry of the journal bearing 150 varying moving circumferentially, the bore geometry may also be referred to as having a circumferentially-varying radial dimension. The result of which is the cross-sectional shape (e.g., the cross-sectional area) of the inner bearing surface 154 being non-circular.

For example, the inner bearing surface 154 (e.g., the cross-sectional shape, or the cross-sectional area thereof, which may be referred to as the inner bearing cross-sectional shape) may include a series of peaks 154a and valleys 154b having smaller and larger radial dimensions, respectively, measured from the axis 134 of rotation of the shaft 130. The radial dimension of the peaks 154a may be referred to as a peak radial dimension or minimum radial dimension, and the radial dimension of the valleys 154b may also be referred to as a valley radial dimension or maximum radial dimension. For example, as shown, the varied radial geometry may include three peaks 154a and three valleys 154b therebetween. The peaks 154a and the valleys 154b may also be referred to as lobes. The peaks 154a and the valleys 154b alternate circumferentially and extend axially over a majority (e.g., an entirety) of the axial distance of the first axially outer region 150d (e.g., between the first axial end 150a and the axially central region 150c of the journal bearing 150, such as on the turbine side) and also the second axially outer region 150e (e.g., between second axial end 150b and the axially central region 150c, such as on the compressor side of the journal bearing 150). As a result, each of the peaks 154a forms an axially-extending ridge and each of the valleys 154b forms an axially-extending trough. The inner fluid film interfaces are formed between the peaks 154a of the inner bearing surface 154 and the outer shaft surface 132 of the shaft 130 (e.g., two inner film interfaces, one in the first axially outer region 150d and another in the second axially outer region 150e).

As shown, the inner bearing surface 154 may include three of the peaks 154a and three of the valleys 154b therebetween, but may include fewer (e.g., two) or more (e.g., four, five, or more). To distinguish from those of the inner housing surface 144, the peaks 154a and the valleys 154b of the inner bearing surface 154 may be referred to as bearing peaks and bearing valleys, respectively, while the peaks 144a and the valleys 144b of the inner housing surface 144 may be referred to as housing peaks and housing valleys, respectively. Alternatively, the inner bearing surface 154 may not vary moving circumferentially (e.g., having a circumferentially non-varying radial dimension), so as to be circular in cross-section at each axial position. For illustrative purposes, the radial dimensions of the journal bearing 150 are depicted in an exaggerated manner, and FIG. 6 superimposes the cross-sectional shape of the various components of the turbocharger 100 to illustrate the different dimensions at different axial positions.

The circumferentially-varying radial dimension of the inner bearing surface 154 may reduce vibrations (e.g., sub-synchronous vibrations), reduce noise, control bearing temperature, increase rotational speed of the shaft 130, and/or increases stability at high rotational speeds of the shaft 130, as compared to conventional geometries of bearing housings and/or journal bearings.

The circumferentially-varying radial dimension may also assist with axial flow of the fluid. Referring to FIGS. 7A-7E, the peaks 154a and the valleys 154b of the inner bearing surface 154 may have a constant angular position or may vary as shown for the peaks 144a and the valleys 144b of the inner housing surface 144.

Axially-Varying Inner Geometry of the Journal Bearing

With the radial dimension of the bore geometry of the journal bearing 150 varying moving axially, the bore geometry of the inner bearing surface 154 (e.g., the inner bearing cross-sectional shape) may also be referred to as having an axially-varying radial dimension. As with varying the bore geometry of the bearing housing 140, by reducing the maximum radial dimension (i.e., of the valleys 154b) moving axially toward the first axial end 150a and the second axial end 150b, greater stability may be provided to the bearing system and reduced noise may be achieved as compared to conventional bearing geometries. The minimum radial dimension (i.e., of the peaks 154a may be constant moving axially). Further by having different smallest dimensions and resultant cross-sectional areas on the turbine and compressor sides, unequal biasing of fluid flow may be achieved between the first axial end 150a of the journal bearing 150 and the second axial end 150b of the journal bearing 150. That is, the fluid may flow in an axial direction between the inner bearing surface 154 and the outer shaft surface 132 at uneven flow rates toward the first axial end 150a and the second axial end 150b.

The axially-varying radial dimension and the axially-varying cross-sectional area of the inner bearing surface 154 are illustrated by comparing the cross-sectional views of FIG. 2 (taken in the axially central region 150c), FIG. 3 (taken at a central position in the first axially outer region 150d), FIG. 4 (taken at an end position in the first axially outer region 150d), FIG. 5 (taken at an end position in the second axially outer region 150e), and FIG. 6 (superimposition of the cross-sections of FIGS. 2-5).

Referring again to FIG. 3, at the central position in the first axially outer region 150d, the inner bearing surface 154 has a maximum radial dimension R_{BI1Cmax} measured from the axis 134 at one or more of the valleys 154b (e.g., all) and a minimum radial dimension R_{BImin} at one or more (e.g., all) of the peaks 154a. At the central position, the difference between the maximum radial dimension R_{BI1Cmax} and the minimum radial dimension R_{BImin} may, for example, be between 2 and 50 microns, such as between 15 and 40 microns, or other suitable dimension.

In the first axially outer region 150d, the maximum radial dimension R_{BI1max} (i.e., of the valleys 154b) of the inner bearing surface 154 may be highest at the central position as compared to any other axial position. The maximum radial dimension R_{BI1max} (i.e., of the valleys 154b) of the inner bearing surface 154 may be highest at the same or different axial position at which the maximum radial dimension R_{HI1max} of the inner housing surface 144 is highest (e.g., being closer to one of the first axial end 150a or the second axial end 150b) and may be at the same or different axial position at which the fluid passage 158a is located.

Moving axially from the central position toward the first axial end 150a, the maximum radial dimension R_{BImax} may decrease and/or stay constant. For example, as shown, the maximum radial dimension R_{BImax} decreases moving from the central position toward the first axial end.

The minimum radial dimension R_{BImin} of the inner bearing surface 154 may, as shown, be constant over the axial distance of the journal bearing 150 (i.e., be the same at each axial position therealong).

As a result of the maximum radial dimension R_{BImax} being highest at the central position and the minimum radial dimension R_{BImin} staying constant, the cross-sectional area A_{BI} of the inner bearing surface 154 (e.g., the inner bearing cross-sectional area) in the first axially outer region 150d may also be highest at the central position. Further, as a result of the maximum radial dimension R_{BImax} decreasing moving from the central position and the minimum radial dimension R_{HImin} staying constant, the cross-sectional area A_{BI} defined within the inner bearing surface 154 decreases moving from the central axial position axially toward the first axial end 150a. Thus, the cross-sectional area of the inner bearing surface 154 varies in size between the central position and the first end position in the first axially outer region 150d (e.g., bearing region).

Referring again to FIG. 4, the maximum radial dimension R_{BImax} of the inner bearing surface 154 may be lowest in the first axially outer region 150d at the first end position. The maximum radial dimension R_{BImax} of the inner bearing surface 154 reduces from its greatest value R_{BI1Cmax} at the central position to its lowest value on the first axially outer region 150d, which is R_{HI1Emax} at the first axial end position (i.e., R_{BI1Cmax}>R_{BI1Emax}).

The maximum radial dimension R_{BImax} may, as shown in FIG. 1, change gradually moving axially. For example, the maximum radial dimension may decrease at an increasing rate moving axially outward (i.e., toward the first axial end 150a), such as by following a curve having a constant or reducing radius (e.g., a parabolic curve), or may decrease at a constant rate (e.g., following a linear path). Alternatively, the maximum radial dimension R_{HImax} may stay constant moving from the central position to the first axial end (i.e., R_{BI1Cmax}=R_{BI1Emax}). The maximum radial dimension R_{BI1Emax} (i.e., of the valleys 154b) of the inner bearing surface 154 may be at the same or different axial position at which the maximum radial dimension R_{HI1Emax} of the inner housing surface 144 is least on the first axial side (e.g., being closer to or further from the first axial end 150a). At the first end position, a difference between the maximum radial dimension R_{HI1max} and the minimum radial dimension R_{HImin} may, for example, be between 2 and 50 microns, such as between 4 and 20 microns, or other suitable dimension.

In the second axially outer region 150e, the maximum radial dimension R_{HBmax} of the inner bearing surface 154 may reduce in the same or similar manner as in the first axially outer region 150d, or may differ (e.g., to provide uneven flow rates as discussed below). Referring again to FIG. 5, the maximum radial dimension R_{BI2max} of the inner bearing surface 154 may be lowest on the second axially outer region 150e at the end position (e.g., at or adjacent the second axial end 150b). Alternatively, the maximum radial dimension R_{HImax} may stay constant moving from the central position to the second axial end (i.e., R_{BI2Cmax}=R_{BI2Emax}). The maximum radial dimension R_{BI2Emax} (i.e., of the valleys 154b) of the inner bearing surface 154 may be at the same or different axial position at which the maximum radial dimension R_{HI2Emax} of the inner housing surface 144 is least on the second axial side 140e (e.g., being closer to or further from the second axial end 150b). At the second end position, a difference between the maximum radial dimension R_{BI2Emax} and the minimum radial dimension R_{BImin} may, for example, be between 2 and 50 microns, such as between 4 and 20 microns, or other suitable dimension.

The maximum radial dimension R_{BImax} of the inner bearing surface 154 may be lowest at the second end position as compared to all other axial positions (i.e., R_{BI2Emax}<R_{BI1Emax}) in the first and second axially outer regions 150d, 150e. As a result of the maximum radial dimension R_{BImax} being least at the second end position and the minimum radial dimension R_{BImin} staying constant, the cross-sectional area A_{BI} of the inner bearing surface 154 may also be lower in second axially outer region 150e than the first axially outer region 150d. Thus, with the outer shaft surface 132 having a constant cross-sectional shape and size (i.e., circular shape with constant diameter, as discussed below), a net cross-sectional area (i.e., A_{BI} minus A_{SO}) is lower in the second axially outer region 150e than in the first axially outer region 150d. This difference in net cross-sectional area provides that fluid flow (e.g., received into the bore 152 through the fluid passage 158a at an axial position between the first axial position and the second axial position, and flowing axially between the inner bearing surface 154 and the outer shaft surface 132) is biased more toward the first axial end 150a than the second axial end 150b. Thus, more fluid is biased toward the first axial end 150a (e.g., toward the turbine 110) than the second axial end 150b (e.g., toward the compressor 120) both between the inner housing surface 144 and the outer bearing surface 156 and between the inner bearing surface 154 and the outer shaft surface 132.

Alternatively, the maximum radial dimension R_{BImax} of the inner bearing surface 154 may be lowest on the opposite side from which the maximum radial dimension R_{BImax} of the inner housing surface 144 is lowest. As a result, more fluid is biased toward the first axial end 150a than the second axial end 150b between the inner housing surface 144 and the outer bearing surface 156, and more fluid is biased toward the second axial end 150b than the first axial end 150a between the inner bearing surface 154 and the outer shaft surface 132, or vice versa.

As referenced above, the shaft 130 has a geometry that does not vary in radial dimension moving circumferentially or axially in regions where the second fluid film interface is formed. That is, the outer surface of the shaft 130 does not vary radially (i.e., is circular) or axially (i.e., is cylindrical) in the axial region coinciding with the journal bearing 150.

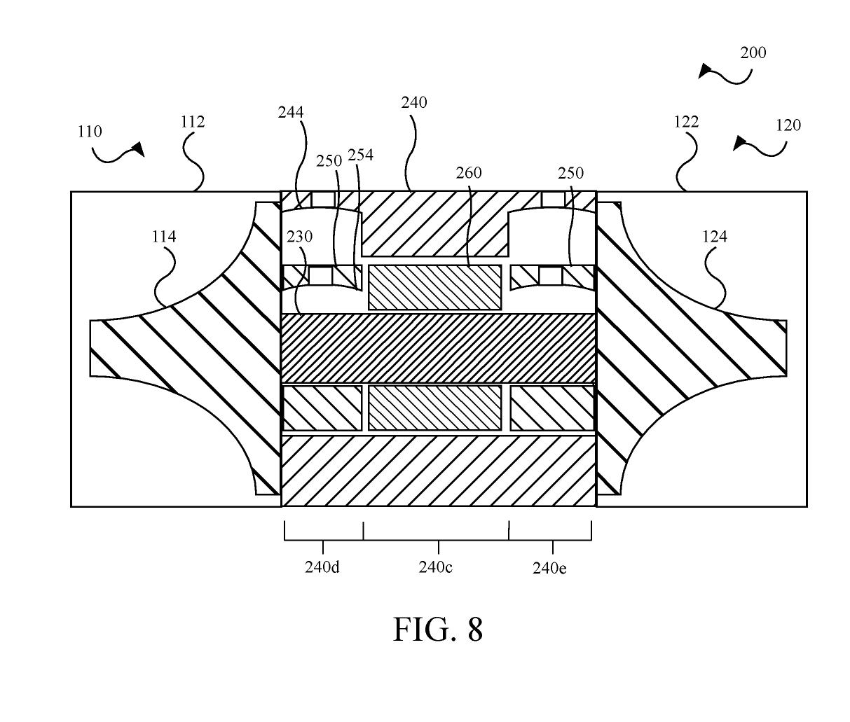

Referring to FIG. 8, a turbocharger 200 may be configured substantially similar to the turbocharger 100 but instead includes two journal bearings 250 (e.g., floating rings or floating journal bearings) that are spaced apart axially along the shaft 130 with a spacer ring 260 (e.g., spacer member) arranged therebetween. In a first axially outer region 240d, the inner housing surface 244 of a bearing housing 240 varies in radial dimension moving both circumferentially (e.g., having peaks and valleys as described above) and axially. For example, the maximum radial dimension (e.g., the valley radial dimension) may be greatest in a central position (e.g., at an axial midpoint of a corresponding one of the journal bearings 250) and reduce therefrom moving axially toward the turbine and toward a central region 240c corresponding to the spacer ring 260. An oil flow passage may be arranged at the axial position corresponding to the greatest maximum radial dimension (e.g., the midpoint). Moving from this midpoint, the maximum radial dimension reduces gradually to both axial ends thereof (e.g., following a curve, such as a parabola, or a line, as described previously). The inner housing surface 244 may be symmetric in the first axially outer region 240d about the midpoint, or may be asymmetric (e.g., having different maximum radial dimensions on each side to bias fluid flow unequally to each side thereof, or by having the maximum radial dimension located off-center). The minimum radial dimension (e.g., of the peaks) may be constant moving axially. The fluid film interface (e.g., the outer fluid film interface) may be formed over the entire axial length of the journal bearing 250. Each of the journal bearings 250 may have an outer bearing surface with a constant outer diameter moving both circumferentially and axially.

In a second axially outer region 240e (i.e., opposite the first axially outer region 240d with the central region 240c arranged therebetween), the inner housing surface 244 may be symmetric to the first axially outer region 240d.

Each of the journal bearings 250 may also be configured in the manners described above with respect to the journal bearing 150 by having an inner bearing surface 254 with a cross-sectional shape that varies in radial dimension moving circumferentially (e.g., for vibrations, etc.) and moving axially (e.g., for stability and/or to control fluid flow therethrough). The maximum radial dimension (e.g., the valley dimension) may be greatest in the central position (e.g., at an axial midpoint thereof) and reduce therefrom moving axially toward the turbine (or compressor) and toward the spacer ring 260. Oil flow passages through the journal bearing 250 may be arranged at the same axial position as the oil flow passage of the bearing housing, and the journal bearing 250 may additionally include a circumferential channel corresponding thereto (e.g., being recessed relative to the outer bearing surface thereof, such as with the circumferential channel 158b) to ensure communication between the oil passage of the bearing housing 240 as the journal bearing rotates relative thereto. Moving axially from the midpoint, the maximum radial dimension reduces gradually to both axial ends thereof (e.g., following a curve, such as a parabola, or line as described previously). The inner bearing surface 254 may be symmetric about the midpoint, or may be asymmetric (e.g., having different maximum radial dimensions on each side thereof to bias fluid flow unequally to each side thereof, or by having the maximum radial dimension located off-center). The minimum radial dimension may be constant moving axially. The fluid film interface (e.g., the inner fluid film interface) may be formed over the entire axial length of the journal bearing 250.

A second of the journal bearings 250 may be a duplicate of a first of the journal bearing 250.

The spacer ring 260 is configured as a ring arranged between the two journal bearings 250. The spacer ring 260 is able to rotate independent of the two journal bearings 250, the shaft 230, and the bearing housing 240. The spacer ring 260 does not support the shaft 230 (e.g., does not form fluid film interfaces therebetween).

The bearing housings 140, 240s and the journal bearing 150, 250 and, particularly, the bore geometries of the inner housing surfaces 144, 244 and the inner bearing surface 154, 254, respectively thereof, may be formed according to any suitable method. A machine, such as a magnetically levitated machine tool and spindle assembly, may apply a rotating cutting tool to the inner surface at suitable axial and radial trajectories in a milling or boring fashion to form the bore geometry thereof. The bearing housing 140 and the journal bearing 150 may be moved axially relative to the cutting tool. For example, the inner housing surface 144 and/or the inner bearing surface 154 may be formed according to the method and with the machine 300 described in U.S. Pat. No. 9,777,597, the entire disclosure of which is incorporated herein by reference.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A turbocharger comprising:
a compressor wheel;
a shaft coupled to the compressor wheel;
a bearing housing through which the shaft extends and which includes an inner housing surface extending circumferentially around an axis of the shaft;
a floating ring that rotatably supports the shaft in the bearing housing and which rotates relative to the bearing housing and the shaft, the floating ring having an outer bearing surface that extends circumferentially around the axis and that faces the inner housing surface;
wherein the inner housing surface is formed of a rigid material and has an inner housing cross-sectional shape that in a first axially outer region of the inner housing surface is non-circular perpendicular to the axis, decreases in area moving axially toward a first axial end of the floating ring, and forms a first outer fluid film interface with the outer bearing surface of the floating ring.

2. The turbocharger according to claim 1, wherein the inner housing surface includes a second axially outer region that is positioned axially opposite the first axially outer region, wherein the inner housing cross-sectional shape in the second axially outer region is non-circular perpendicular to the axis, decreases in area moving axially toward a second axial end of the floating ring, and forms a second outer fluid film interface with the outer bearing surface of the floating ring.

3. The turbocharger according to claim 2, wherein the inner housing surface includes an axially central region between the first axially outer region and the second axially outer region, wherein the inner housing cross-sectional shape is greater area in the axially central region than in each of the first axially outer region and the second axially outer region.

4. The turbocharger according to claim 3, wherein the inner housing surface does not form a fluid film interface with the outer bearing surface in the axially central region.

5. The turbocharger according to claim 3, wherein the area of the inner housing cross-sectional shape reduces in a stepped manner moving axially from the axially central region to each of the first axially outer region and the second axially outer region.

6. The turbocharger according to claim 5, wherein in each of the first axially outer region and the second axially outer region, a maximum radial dimension decreases gradually and a minimum radial dimension is constant moving axially away from the axially central region.

7. The turbocharger according to claim 3, wherein the bearing housing includes a fluid passage having an outlet through which fluid enters the bearing housing, the outlet being located in the axially central region of the inner housing surface.

8. The turbocharger according to claim 2, wherein the inner housing cross-sectional shape includes a first minimum cross-sectional area in the first axially outer region and a second minimum cross-sectional area in the second axially outer region, the first minimum cross-sectional area being less than the second minimum cross-sectional area.

9. The turbocharger according to claim 1, wherein the inner housing cross-sectional shape includes peaks and valleys that extend axially toward the first axial end, wherein in the first axially outer region, the peaks have a peak radial dimension measured from the axis that is constant moving axially toward the first axial end, and the valleys have a valley radial dimension measured from the axis that is greater than the peak radial dimension and that reduces moving axially toward the first axial end.

10. The turbocharger according to claim 1, wherein the floating ring includes an outer bearing surface that extends circumferentially around the axis and that has a radial dimension that is constant in a first axially outer region of the floating ring that corresponds to the first axially outer region of the inner housing surface.

11. The turbocharger according to claim 10, wherein the floating ring includes an inner bearing surface having an inner bearing cross-sectional shape that is non-circular perpendicular to the axis.

12. The turbocharger according to claim 11, wherein the inner bearing cross-sectional shape reduces in area moving toward the first axial end.

13. The turbocharger according to claim 12, wherein the inner bearing cross-sectional shape includes peaks and valleys, the peaks having a peak radial dimension measured from an axis of the floating ring, and the valleys having a valley radial dimension measured from the axis that is greater than the peak radial dimension and that reduces moving toward the first axial end.

14. The turbocharger according to claim 1, wherein the inner housing surface includes a second axially outer region that is positioned axially opposite the first axially outer region, wherein the inner housing cross-sectional shape in the second axially outer region is non-circular perpendicular to the axis, decreases in area moving axially toward a second axial end of the floating ring, and forms a second outer fluid film interface with the outer bearing surface of the floating ring;
wherein the inner housing surface includes an axially central region between the first axially outer region and the second axially outer region, wherein the inner housing cross-sectional shape is greater area in the axially central region than in each of the first axially outer region and the second axially outer region;
wherein the area of the inner housing cross-sectional shape reduces in a stepped manner moving axially from the axially central region to each of the first axially outer region and the second axially outer region;
wherein the inner housing surface does not form a fluid film interface with the outer bearing surface in the axially central region.
wherein in each of the first axially outer region and the second axially outer region, a maximum radial dimension decreases gradually and a minimum radial dimension is constant moving axially away from the axially central region; and
wherein the bearing housing includes a fluid passage having an outlet through which fluid enters the bearing housing, the outlet being located in the axially central region of the inner housing surface.

15. A turbocharger comprising:
a turbine having a turbine housing and a turbine wheel in the turbine housing;
a compressor having a compressor housing and a compressor wheel in the compressor housing;
a shaft that by which the turbine wheel is rotatably coupled to the compressor wheel, the shaft having an outer shaft surface; and
a bearing housing between the turbine housing and the compressor housing and through which the shaft extends, the bearing housing having an inner housing surface with a cross-sectional shape that is non-circular and that varies in size moving along an axis of the shaft; and
a floating journal bearing positioned radially between and rotatable independent of the inner housing surface and the outer shaft surface, the floating journal bearing having an outer bearing surface;
wherein a first fluid film interface is formed between the inner housing surface and the outer bearing surface.

16. The turbocharger according to claim 15, wherein the floating journal bearing has an inner bearing surface, and a second fluid film interface is formed between the inner bearing surface and the outer shaft surface.

17. The turbocharger according to claim 16, wherein the inner bearing surface has a second cross-sectional shape that is non-circular and that varies in size moving along the axis of the shaft.

18. The turbocharger according to claim 15, further comprising another floating journal bearing positioned radially between and rotatable independent of the inner housing surface and the outer shaft surface, and positioned axially between the turbine and the floating journal bearing, wherein another fluid film interface is formed between the inner housing surface and another outer bearing surface of the other floating journal bearing.

19. The turbocharger according to claim 18, further comprising a spacer ring positioned that is axially between the floating journal bearing and the other journal bearing.

20. A turbocharger comprising:
a shaft coupled to a turbine wheel and a compressor wheel at opposite ends thereof;
a bearing housing having an inner housing surface with a radial dimension that varies moving circumferentially about an axis thereof and moving axially therealong, the inner housing surface defining a first bore;
a bearing having an outer bearing surface with another radial dimension that is constant moving circumferentially about another axis thereof and moving axially therealong, and an inner bearing surface that defines a second bore;
wherein the bearing is positioned in the first bore, the shaft extends through the second bore, a first fluid film interface is formed between the inner housing surface and the outer bearing surface, a second fluid film interface is formed between the inner housing surface and the shaft, and the bearing rotates independent of the bearing housing and the shaft.
